(19) United States
(12) Patent Application Publication
(10) Pub. No.: US 2010/0049900 A1
(43) Pub. Date: Feb. 25, 2010

(54) MEMORY CARD AND NON-VOLATILE MEMORY CONTROLLER THEREOF

(75) Inventor: Chin-Hung Chiou, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INCOMM TECHNOLOGIES CO., LTD., Taipei (TW)

(21) Appl. No.: 12/241,053

(22) Filed: Sep. 30, 2008

(30) Foreign Application Priority Data
Aug. 20, 2008 (TW) 97131804

(51) Int. Cl. G06F 12/02; G06F 9/44; G06F 12/00

(52) U.S. Cl. 711/103; 717/168; 711/115; 711/E12.001; 711/E12.008

(57) ABSTRACT

A memory card and a non-volatile memory controller thereof are provided. The non-volatile memory controller provides a process interface to allow a host to access a non-volatile memory. The non-volatile memory controller includes a mode setting port group, a firmware download port group, a host access port group, a memory port group, a control unit, a processing unit, an interface unit, and a switch unit. When a firmware in the non-volatile memory is to be updated, the switch unit switches to the firmware download port group and then connects it to a fixture to obtain a new firmware. The control unit writes the new firmware into the non-volatile memory directly on a printed circuit board according to an instruction of the process unit. Thereby, in the present invention, firmware updating can be carried out directly on a printed circuit board therefore is made more convenient.

### CROSS-REFERENCE TO RELATED APPLICATION

This application claims the priority benefit of Taiwan application serial no. 97131804, filed on Aug. 20, 2008. The entirety of the above-mentioned patent application is hereby incorporated by reference herein and made a part of this specification.

### BACKGROUND OF THE INVENTION

1. Field of the Invention

The present invention generally relates to a non-volatile memory controller, and more particularly, to a non-volatile memory controller which can update a firmware directly on a printed circuit board and a memory card using the same.

2. Description of Related Art

Along with the rapid advancement of information technology, storage media developed based on semiconductor techniques have become the mainstream products and which are generally referred to as portable memories, flash memory cards, or memory cards. Compared to the conventional floppy disk and compact disk, portable memory is far more advantageous in its functional characteristics, such as portability, power consumption, data storage, data transmission rate, reread or rewrite, and vibration and damp proof. Due to all these advantages of portable memory, every international electronic product manufacturer has promoted its own portable memory, such as Smart card, PC card (PCMCIA ATA Flash Card), CF card (CompactFlash Card), SM card (Smart Media Card), MMC card (MultiMedia Card), MS card (Memory Stick Card), and SD card (Secure Digital Card), etc, and these portable memories are broadly applied to various digital products. Generally, after a memory card is manufactured, a firmware has to be written into the memory card by using a special fixture called MP-tooling (usually provided by the manufacturer of the memory card).

FIG. 1 is a functional block diagram illustrating how a firmware is written into a conventional multi-chip package (MCP) memory card. Referring to FIG. 1, the MCP integrated circuit (IC) 110 includes a non-volatile memory controller 120 and a plurality of non-volatile memories 160 and 170. The non-volatile memory controller 120 further includes an interface circuit 121, a processing unit 122, a control unit 123, a host access port group 124, and memory port groups 125 and 126. The MCP IC 110 may be a memory chip package conforming to the specification of Smart card, PC card, or SD card, etc.

Herein it is assumed that the non-volatile memory controller 120 is a SD memory card controller and the non-volatile memories 160 and 170 are flash memory chips. An external device, for example, a host 140, of the MCP IC 110 is connected to the non-volatile memory controller 120 through the host access port group 124. If the host 140 is about to access the non-volatile memory 160 or 170, the host 140 has to send a signal conforming to the specification of SD memory card to the interface circuit 121. After a fixture 180 receives a new firmware, the fixture 180 sends the new firmware to the processing unit 122 through the host access port group 124 and the interface circuit 121, and the processing unit 122 then writes the new firmware into the non-volatile memory 160 through the control unit 123.

In another conventional firmware updating technique, when the memory card becomes invalid or has compatibility problem and accordingly the firmware in the MCP IC 110 is to be updated, the MCP IC 110 soldered on a printed circuit board (PCB) is de-soldered (i.e., removed from the PCB) and then loaded into a specific firmware update fixture to be written with the new firmware. This conventional technique is very inconvenient and costly.

### SUMMARY OF THE INVENTION

Accordingly, the present invention is directed to a non-volatile memory controller which can update a firmware directly on a printed circuit board, such that firmware updating is made more convenient.

The present invention is also directed to a memory card which can update a firmware directly on a printed circuit board.

The present invention provides a non-volatile memory controller which provides a process interface to allow a host to access a non-volatile memory. The non-volatile memory controller includes a mode setting port group, a firmware download port group, a host access port group, a memory port group, a control unit, a processing unit, an interface unit, and a switch unit. The firmware download port group receives a new firmware. The host access port group is used for coupling to the host. The memory port group is used for coupling to the non-volatile memory. The control unit is coupled to the memory port group. The processing unit is coupled to the control unit, and the processing unit accesses the non-volatile memory through the control unit. The interface unit is coupled to the processing unit. A first terminal of the switch unit is coupled to the host access port group, a second terminal thereof is coupled to the firmware download port group, and a third terminal thereof is coupled to the interface unit. The processing unit controls the interface unit to couple a third terminal of the interface unit to a first terminal or a second terminal thereof according to a logic state received by the mode setting port group.

The present invention also provides a memory card including a non-volatile memory and a non-volatile memory controller. The non-volatile memory controller includes a mode setting port group, a firmware download port group, a host access port group, a memory port group, a control unit, a processing unit, an interface unit, and a switch unit. The firmware download port group receives a new firmware. The host access port group is coupled to a host. The memory port group is coupled to the non-volatile memory. The control unit is coupled to the memory port group. The processing unit is coupled to the control unit, and the processing unit accesses the non-volatile memory through the control unit. The interface unit is coupled to the processing unit. A first terminal of the switch unit is coupled to the host access port group, a second terminal thereof is coupled to the firmware download port group, and a third terminal thereof is coupled to the interface unit. The processing unit controls the interface unit to couple a third terminal of the interface unit to a first terminal or a second terminal thereof according to a logic state received by the mode setting port group.

The present invention further provides a non-volatile memory controller including a first memory port group, a second memory port group, a control unit, a processing unit, an interface unit, and a mode setting port group. The first memory port group is used for coupling to a first non-volatile memory. The second memory port group is used for coupling to a second non-volatile memory, wherein the second memory port group is further served as a firmware download port group. The control unit is coupled to the first memory port group and the second memory port group. The processing unit is coupled to the control unit, and the processing unit accesses the first non-volatile memory or the second non-volatile memory through the control unit. The interface unit is coupled to the processing unit, wherein the processing unit provides a process interface through the interface unit to allow a host to access the first non-volatile memory or the second non-volatile memory. The processing unit controls the control unit according to a logic state of the mode setting port group to determine whether the control unit executes an instruction received through the firmware download port group.

The present invention further provides a memory card including a first non-volatile memory, a second non-volatile memory, and a non-volatile memory controller. The non-volatile memory controller includes a first memory port group, a second memory port group, a control unit, a processing unit, an interface unit, and a mode setting port group. The first memory port group is coupled to the first non-volatile memory. The second memory port group is coupled to the second non-volatile memory, wherein the second memory port group is further served as a firmware download port group. The control unit is coupled to the first memory port group and the second memory port group. The processing unit is coupled to the control unit, and the processing unit accesses the first non-volatile memory or the second non-volatile memory through the control unit. The interface unit is coupled to the processing unit, wherein the processing unit provides a process interface through the interface unit to allow a host to access the first non-volatile memory or the second non-volatile memory. The processing unit controls the control unit according to a logic state of the mode setting port group to determine whether the control unit executes an instruction received through the firmware download port group.

According to an embodiment of the present invention, the non-volatile memory controller and the non-volatile memory are packaged together in a multi-chip package (MCP).

According to an embodiment of the present invention, the host access port group is disposed at a lower side of the MCP to be soldered on a printed circuit board (PCB), the firmware download port group is disposed on an upper side of the MCP, and the mode setting port group may be disposed on the upper side of the MCP.

According to another embodiment of the present invention, the host access port group is disposed in the center area of a lower side of the MCP to be soldered on a PCB, the firmware download port group is disposed at an edge area of the lower side of the MCP, and the mode setting port group may be disposed at the edge area of the lower side of the MCP.

According to an embodiment of the present invention, the non-volatile memory controller and the non-volatile memory are respectively packaged in different packages, wherein the host access port group and the memory port group are disposed at a packaged lower side of the non-volatile memory controller to be soldered on a PCB, the firmware download port group is disposed on a packaged upper side of the non-volatile memory controller, and the mode setting port group is disposed on the packaged upper side of the non-volatile memory controller.

According to another embodiment of the present invention, the host access port group and the memory port group are disposed in the center area of a packaged lower side of the non-volatile memory controller to be soldered on a PCB, the firmware download port group is disposed at an edge area of the packaged lower side of the non-volatile memory controller, and the mode setting port group may be disposed at the edge area of the packaged lower side of the non-volatile memory controller.

According to an embodiment of the present invention, the switch unit of the non-volatile memory controller is a multiplexer or a switch.

According to an embodiment of the present invention, the non-volatile memory controller further serves the firmware download port group as a second memory port group to be coupled to a second non-volatile memory, and the control unit is further coupled to the second memory port group to allow the processing unit to access the second non-volatile memory through the control unit.

Thereby, when the firmware in the non-volatile memory is to be updated, the switch unit switches to the firmware download port group to allow the processing unit to obtain a new firmware, and the control unit writes the new firmware into the non-volatile memory directly on the circuit board according to the instruction of the processing unit. As a result, firmware updating is made more convenient. Moreover, by sharing a port group between different functions, the cost of the memory card in the present invention is not increased and no additional pin is disposed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a functional block diagram illustrating how a firmware is written into a conventional multi-chip package (MCP) memory card.

FIG. 2 is a functional block diagram of a memory card according to an embodiment of the present invention.

FIG. 3A is a diagram of a switch unit according to an embodiment of the present invention.

FIG. 3B is a diagram of a switch unit according to another embodiment of the present invention.

FIG. 4 is a functional block diagram of a non-volatile memory controller according to an embodiment of the present invention.

FIG. 5 is a functional block diagram of a non-volatile memory controller according to another embodiment of the present invention.

FIG. 6 is a diagram illustrating the disposition of pins of a MCP according to an embodiment of the present invention.

FIG. 7 is a diagram illustrating the connection between a MCP and a fixture according to an embodiment of the present invention.

FIG. 8 is an exploded view illustrating the connection between a MCP and a fixture according to another embodiment of the present invention.

FIG. 9 is an exploded view illustrating the connection between a MCP and a fixture according to yet another embodiment of the present invention.

FIG. 10 is a flowchart of a firmware updating process according to an embodiment of the present invention.

FIG. 11 is a functional block diagram of a memory card according to an embodiment of the present invention.

FIG. 12 is a functional block diagram of a non-volatile memory controller according to another embodiment of the present invention.

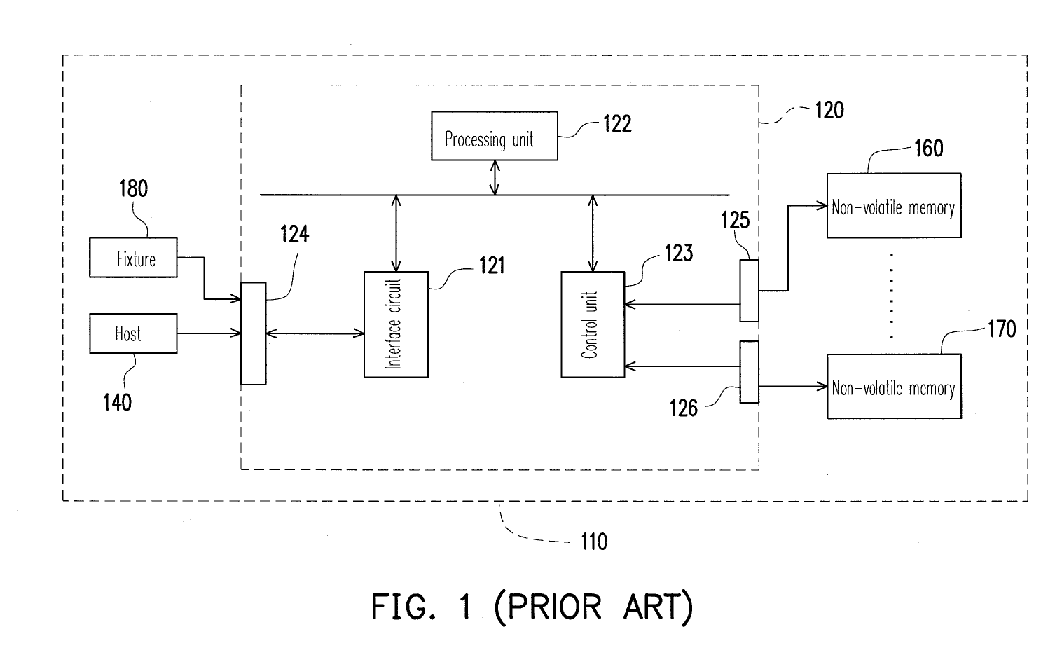

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

### First Embodiment

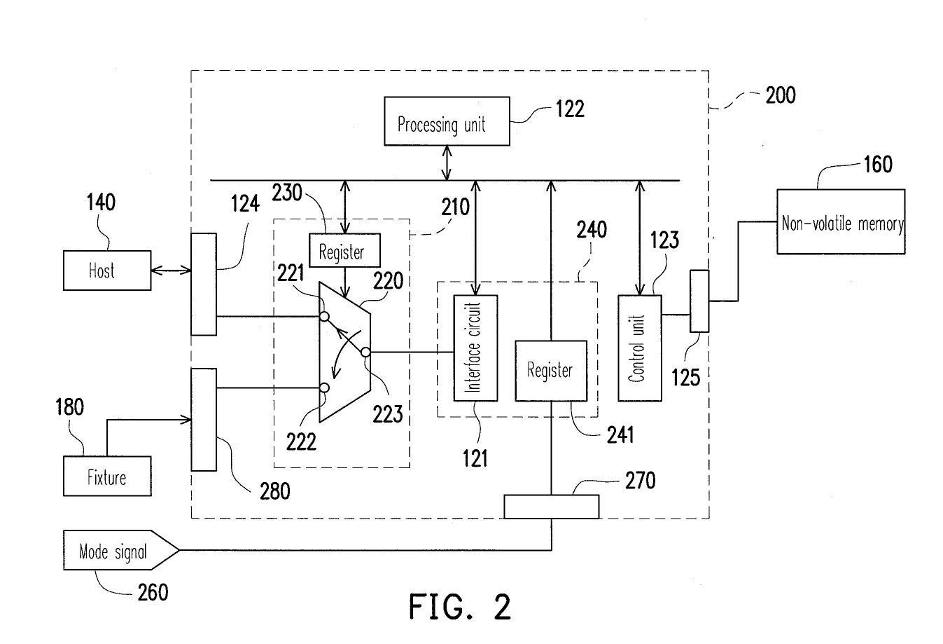

FIG. 2 is a functional block diagram of a memory card according to the first embodiment of the present invention. Referring to FIG. 2, the memory card includes a non-volatile memory controller 200 and a non-volatile memory 160. The non-volatile memory controller 200 provides a process interface between a host 140 and the non-volatile memory 160 to allow the host 140 to access the non-volatile memory 160. In the present embodiment, both the non-volatile memory controller 200 and the non-volatile memory 160 are packaged in multi-chip packages (MCPs). In the present embodiment, the non-volatile memory controller 200 may be designed into a memory card controller of any type or any pattern. For example, the non-volatile memory controller 200 may be a memory card controller conforming to the specification of any common memory card in the market, such as a Smart card, a PC card, a CF card, a SM card, a MMC card, a MS card, or a SD card. Besides, in the present embodiment, the non-volatile memory 160 may be any programmable read-only memory, such as a flash memory or an electrically erasable programmable read-only memory (EEPROM).

The non-volatile memory controller 200 includes an interface unit 240, a processing unit 122, a control unit 123, a switch unit 210, a host access port group 124, a firmware download port group 280, a mode setting port group 270, and a memory port group 125. The host access port group 124, the firmware download port group 280, the mode setting port group 270, and the memory port group 125 may be bounding pad groups of the non-volatile memory controller 200. The interface unit 240 includes an interface circuit 121 and a register 241, and the switch unit 210 includes a multiplexer 220 and a register 230. The first terminal 221, the second terminal 222, and the third terminal 223 of the multiplexer 220 are respectively served as the first terminal, the second terminal, and the third terminal of the switch unit 210.

The host access port group 124 is coupled to the first terminal 221 of the multiplexer 220, and the firmware download port group 280 is coupled to the second terminal 222 of the multiplexer 220. The third terminal 223 of the multiplexer 220 is coupled to the interface unit 240. The memory port group 125 may be coupled to the non-volatile memory 160. The control unit 123 is coupled to the processing unit 122 and the memory port group 125. The control unit 123 accesses the non-volatile memory 160 according to a signal of the processing unit 122. In other words, the processing unit 122 accesses the non-volatile memory 160 through the control unit 123.

The processing unit 122 receives a mode signal 260 through the interface unit 240 and the mode setting port group 270 and controls the switch unit 210 to switch between the first, the second, and the third terminal according to the logic state of the mode signal 260, so as to selectively couple the interface unit 240 to the host access port group 124 or the firmware download port group 280. For example, if the mode signal 260 is at high level, the processing unit 122 controls the switch unit 210 to connect the third terminal 223 of the multiplexer 220 to the first terminal 221 thereof, so that the non-volatile memory controller 200 can provide a process interface to the host 140 to allow the host 140 to access the non-volatile memory 160. Contrarily, if the mode signal 260 received by the processing unit 122 through the mode setting port group 270 is at low level, the processing unit 122 controls the switch unit 210 to connect the third terminal 223 of the multiplexer 220 to the second terminal 222 thereof, so that the non-volatile memory controller 200 is temporarily disconnected from the host 140 and the process interface is provided to a fixture 180 to allow the fixture 180 to update the firmware in the non-volatile memory 160.

The registers 230 and 241 are respectively used for temporarily storing an instruction of the processing unit 122 and the mode signal 260. The operation of the processing unit 122 corresponding to the logic state of the mode signal 260 is not limited in the present embodiment; instead, it can be determined according to the actual requirement of a circuit designer. Besides, in the present embodiment, the mode setting port group 270 is coupled to the interface unit 240; however, the present invention is not limited thereto, and the mode setting port group 270 may also be coupled to the control unit 123 or directly to the processing unit 122.

If the host 140 is about to access the non-volatile memory 160, the mode signal 260 is sent to the register 241 in the interface unit 240 through the mode setting port group 270. When the processing unit 122 receives the mode signal 260 from the register 241, it controls the switch unit 210 to connect the third terminal 223 of the multiplexer 220 to the first terminal 221 thereof, so that the interface circuit 121 can be connected to the host access port group 124. Accordingly, the host 140 can be coupled to the non-volatile memory controller 200 through the host access port group 124 and accesses the non-volatile memory 160.

It should be noted that if a firmware stored in the non-volatile memory 160 is to be updated (in the present embodiment, the firmware is assumed to be stored in the non-volatile memory 160), the processing unit 122 issues a switch command to the switch unit 210 according to the mode signal 260 to connect the third terminal 223 of the multiplexer 220 to the second terminal 222 thereof, so that the interface circuit 121 is connected to the firmware download port group 280. Accordingly, the non-volatile memory controller 200 is connected to the fixture 180 through the firmware download port group 280. Then the fixture 180 sends the new firmware to the interface circuit 121 through the firmware download port group 280 and the switch unit 210 according to the predetermined memory card standard (for example, the standard of CF card, SM card, MMC card, MS card, or SD card). The processing unit 122 then obtains the new firmware through the interface circuit 121. The processing unit 122 issues a write command to the control unit 123 to allow the control unit 123 to write the new firmware into the non-volatile memory 160 through the memory port group 125. By now, the firmware updating process is completed.

Because the processing unit 122 switches the electrical path between the first terminal of the switch unit 210 (i.e., the first terminal 221 of the multiplexer 220) and the host 140 into a floating state (i.e., an off state) according to the mode signal 260, the problem of bus contention can be avoided in foregoing firmware updating process. Thus, the non-volatile memory controller 200 provided by the present invention can update a firmware directly on a printed circuit board, and accordingly firmware updating is made very convenient.

In the embodiment described above, the non-volatile memory controller 200 and the non-volatile memory 160 may be integrated into the same integrated circuit (IC, or chip) or may also be implemented respectively in different ICs (or chips). If the non-volatile memory controller 200 and the non-volatile memory 160 are respectively implemented in different ICs (or chips), they can be fabricated through any packaging technique. For example, the non-volatile memory controller 200 and the non-volatile memory 160 may be packaged together in a MCP. Or, the non-volatile memory controller 200 and the non-volatile memory 160 may also be respectively packaged in different IC packages.

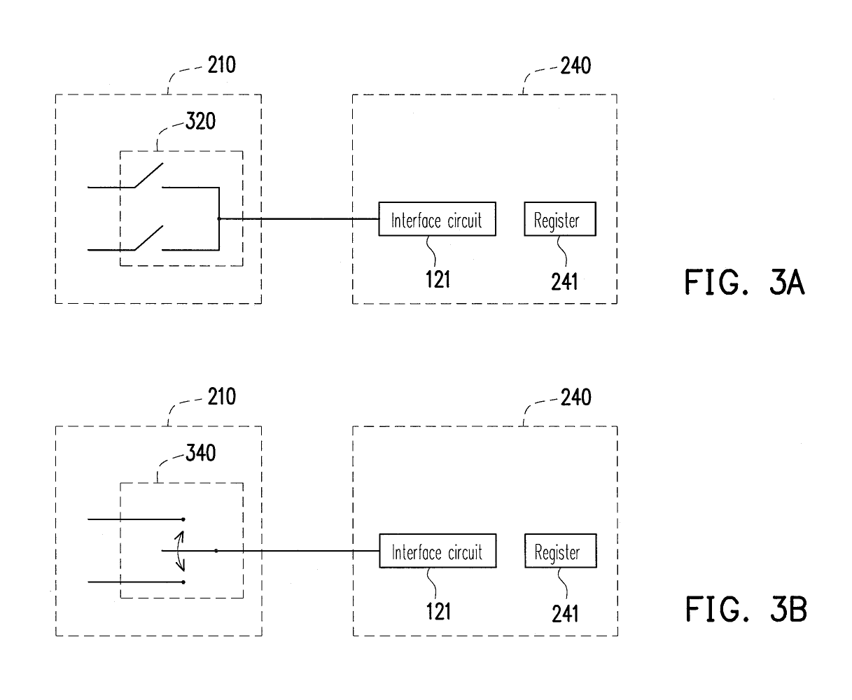

In addition, the multiplexer 220 may also be replaced by a switch device (such as the switch 320 in FIG. 3A and the switch 340 in FIG. 3B). The registers 230 and 241 are only examples used in the present embodiment but not limited thereto. For example, the registers 230 and 241 may also be replaced by memory devices, such as buffers or latches.

### Second Embodiment

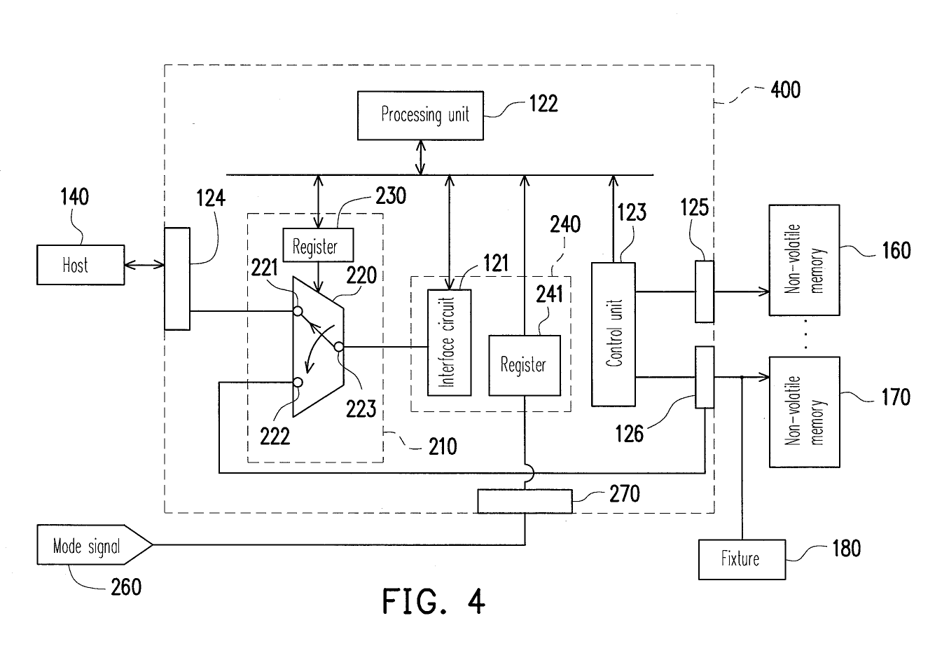

FIG. 4 is a functional block diagram of a non-volatile memory controller according to the second embodiment of the present invention. Referring to FIG. 4 and FIG. 2, the difference between the second embodiment and the first embodiment is that in the second embodiment, the port group 126 is a common port group served as the memory port group of the second non-volatile memory 170 and the firmware download port group for connecting the fixture 180 to the non-volatile memory controller 400. The other blocks in FIG. 4 have the same functions as those in FIG. 2 therefore will not be described herein.

In some embodiments of the present invention, the non-volatile memory controller 400 may be connected to a plurality of non-volatile memories, such as the non-volatile memories 160 and 170 in the present embodiment. In the present embodiment, it is assumed that the non-volatile memory 160 is used for storing a firmware and the non-volatile memory 170 is used by the host 140 for storing general data (such as text files, music files, and image files, etc). The control unit 123 issues a chip selection signal such that the processing unit 122 can enable one of a plurality of non-volatile memories (160 and 170) and disable the other unselected non-volatile memories. Thus, to update the firmware stored in the non-volatile memory 160, no action is taken to the non-volatile memory 170 and the second memory port group 126 is idled. Thus, the memory port group 126 can be served as the firmware download port group when the firmware is updated, namely, the same port group is shared by different functions.

Thereby, to update the firmware stored in the non-volatile memory 160, the processing unit 122 issues a switch command to the switch unit 210 according to the mode signal 260 to connect the third terminal 223 of the multiplexer 220 to the second terminal 222 thereof, so that the interface circuit 121 is connected to the common port group 126 (i.e., the memory port group 126). Accordingly, the non-volatile memory controller 200 is connected to the fixture 180 used for updating the firmware through the common port group 126 to obtain the new firmware. Then the processing unit 122 obtains the new firmware through the interface circuit 121 and issues a write command to the control unit 123. The control unit 123 then writes the new firmware into the non-volatile memory 160 through the memory port group 125. By now, the firmware updating process is completed.

The mode signal 260 indicates that the fixture 180 used for updating the firmware is already removed when the firmware is not to be updated. Thereby, the host 140 can still access the non-volatile memories 160 and 170 through the non-volatile memory controller 400. The mode signal 260 indicates that the memory port group 126 is served as the firmware download port group when the firmware is updated. By sharing the same port group between different functions, the layout area taken by port groups (or bounding pads) in the non-volatile memory controller 400 and the cost of the non-volatile memory controller 400 can be reduced.

In the embodiment described above, the non-volatile memory controller 400 and the non-volatile memories 160 and 170 may be integrated into the same IC (or chip) or may also be implemented respectively in different ICs (or chips). If the non-volatile memory controller 400 and the non-volatile memories 160 and 170 are respectively implemented into different ICs (or chips), they can be fabricated through any packaging technique. For example, the non-volatile memory controller 400 and the non-volatile memories 160 and 170 may be packaged together into a MCP. Or, the non-volatile memory controller 400 and the non-volatile memories 160 and 170 may also be respectively packaged into different IC packages.

The firmware updating method described above may also be changed appropriately by those having ordinary knowledge in the art according to the description of foregoing embodiment. For example, in another embodiment of the present invention, the electrical path between the control unit 123 and the internal bus of the non-volatile memory controller 400 may be switched to a floating state (i.e., an off state). In other words, the processing unit 122 can temporarily disables the connection between the control unit 123 and the internal bus of the non-volatile memory controller 400 according to the logic state of the mode signal 260 received by the mode setting port group 270, so that the fixture 180 can send an instruction and the new firmware to the control unit 123 through the second memory port group 126 without being interfered by the internal bus of the non-volatile memory controller 400. After that, the control unit 123 writes the new firmware into the non-volatile memory 160 through the memory port group 125.

In yet another embodiment of the present invention, the processing unit 122 may also disable the functions of the switch unit 210 and the interface circuit 121 according to the mode signal 260. Then the fixture 180 connected to the second memory port group 126 can issue an instruction to the control unit 123 so that the control unit 123 can write the new firmware into the non-volatile memory 160 through the memory port group 125. As described above, in the present embodiment, the fixture 180 can directly update the firmware in the non-volatile memory 160 through the control unit 123.

### Third Embodiment

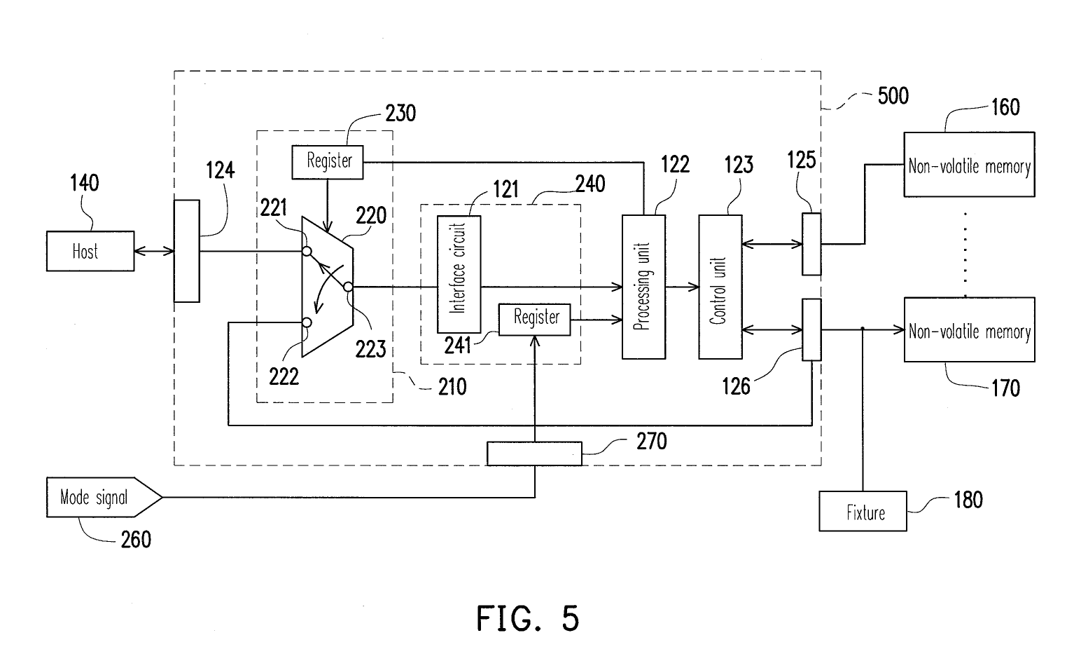

FIG. 5 is a functional block diagram of a non-volatile memory controller according to the third embodiment of the present invention. Referring to FIG. 5, compared to the first and the second embodiment, in the third embodiment, the processing unit 122 of the non-volatile memory controller 500 is connected between the interface unit 240 and the control unit 123 in series. To update the firmware, the mode signal 260 is sent to the register 241 through the mode setting port group 270. When the processing unit 122 receives the mode signal 260 from the register 241, the processing unit 122 issues a switch command to the register 230 according to the logic state of the mode signal 260. The multiplexer 220 switches the third terminal 223 to the second terminal 222 and floats the first terminal 221 according to the switch command in the register 230. Accordingly, the fixture 180 can send the new firmware to the processing unit 122 through the port group 126, the switch unit 210, and the interface unit 240 sequentially. The control unit 123 writes the new firmware into the non-volatile memory 160 according to the instruction of the processing unit 122. In other words, the processing unit 122 accesses the non-volatile memories 160 and 170 through the control unit 123.

### Fourth Embodiment

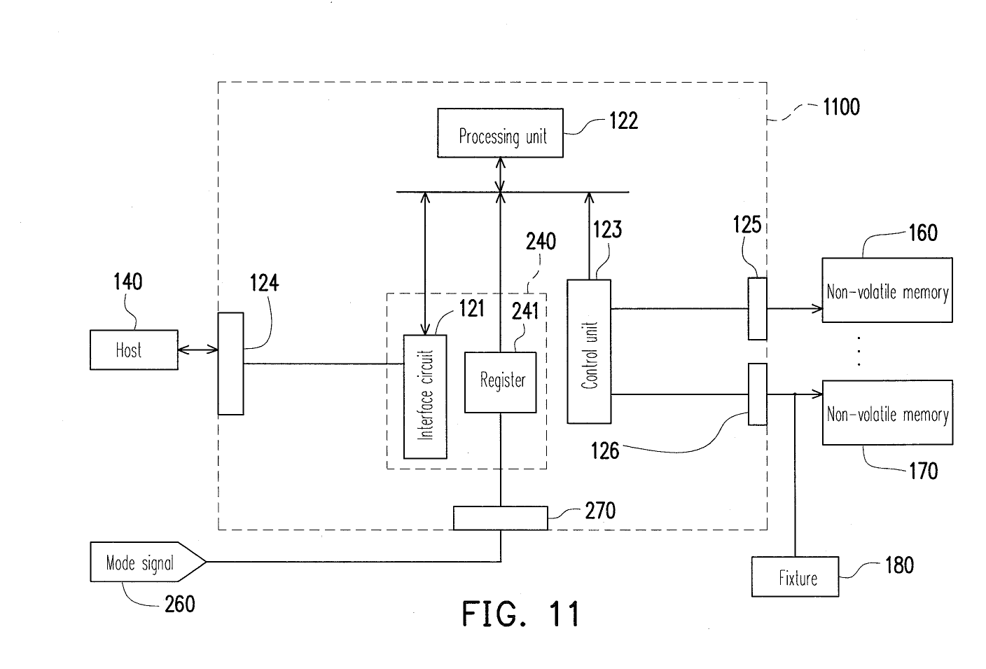

FIG. 11 is a functional block diagram of a memory card according to an embodiment of the present invention. Referring to FIG. 11, the memory card includes a non-volatile memory controller 1100, a first non-volatile memory 160, and a second non-volatile memory 170. The non-volatile memory controller 1100 provides a process interface between a host 140 and the non-volatile memories 160 and 170 to allow the host 140 to access the non-volatile memories 160 and 170.

In the present embodiment, the first non-volatile memory 160 is used for storing a firmware, and the second non-volatile memory 170 is used for storing general data (for example, document files, music files, and image files, etc) written by the host 140. The processing unit 122 selects and enables one of the non-volatile memories (160 and 170) and disables the others according to a chip selection signal issued by the control unit 123. Thus, no operation is performed to the second non-volatile memory 170 when the firmware stored in the first non-volatile memory 160 is updated, and herein the second memory port group 126 is idled. Accordingly, the second memory port group 126 can be served as a firmware download port group (i.e., the same port group is shared by two different functions) when the firmware is updated.

In the present embodiment, the non-volatile memory controller 1100 and the non-volatile memories 160 and 170 are all packaged into a MCP. The non-volatile memory controller 1100 in the present embodiment may be designed as a memory card controller of any type or any pattern. For example, the non-volatile memory controller 1100 may be a memory card controller conforming to the standard of a Smart card, a PC card, a CF card, a SM card, a MMC card, a MS card, or a SD card. In addition, the non-volatile memories 160 and 170 in the present embodiment may be any programmable read-only memories, such as flash memories and electrically erasable programmable read-only memories (EEPROM), etc.

The non-volatile memory controller 1100 includes an interface unit 240, a processing unit 122, a control unit 123, a host access port group 124, a mode setting port group 270, a first memory port group 125, and a second memory port group 126, wherein the second memory port group 126 is further served as a firmware download port group such that an external fixture can be connected to the control unit 123 through the firmware download port group (i.e., the second memory port group 126). The host access port group 124, the mode setting port group 270, the first memory port group 125, and the second memory port group 126 may be bounding pad groups of the non-volatile memory controller 1100.

The first memory port group 125 is used for connecting to the first non-volatile memory 160, and the second memory port group 126 is used for connecting to the second non-volatile memory 170. The control unit 123 is coupled to the processing unit 122, the first memory port group 125, and the second memory port group 126. The control unit 123 accesses the non-volatile memory 160 or 170 according to a signal of the processing unit 122. In other words, the processing unit 122 accesses the non-volatile memory 160 or 170 through the control unit 123.

The interface unit 240 includes an interface circuit 121 and a register 241. The host access port group 124 is coupled to the interface circuit 121 of the interface unit 240. Accordingly, the non-volatile memory controller 1100 can provide a process interface to the host 140 such that the host 140 can access the first non-volatile memory 160 through the host access port group 124, the interface circuit 121, and the control unit 123.

The register 241 is used for temporarily storing a mode signal 260. The processing unit 122 receives the mode signal 260 through the register 241 and the mode setting port group 270 and controls the control unit 123 according to the logic state of the mode signal 260 received through the mode setting port group 270 to determine whether the control unit 123 executes an instruction received through the firmware download port group 126. For example, if the mode signal 260 is a high level signal, the processing unit 122 disables the interface unit 240 and controls the control unit 123 through the firmware download port group 126. Accordingly, an external fixture 180 sends an instruction and a new firmware to the control unit 123 through the firmware download port group 126, and the control unit 123 writes the new firmware into the first non-volatile memory 160 through the first memory port group 125. In other words, the control unit 123 which is controlled by the fixture 180 can writes the new firmware provided by the fixture 180 into the first non-volatile memory 160.

The operation of the processing unit 122 corresponding to the logic state of the mode signal 260 is not limited in the present embodiment and which can be determined according to the actual requirement of a circuit designer. Additionally, in the present embodiment, the mode setting port group 270 is coupled to the interface unit 240. However, the coupling of the mode setting port group 270 is not limited in the present embodiment, and the mode setting port group 270 may also be coupled to the control unit 123 or directly to the processing unit 122.

As described above, when the host 140 is about to access the non-volatile memory 160 or 170, the mode signal 260 is transmitted to the register 241 in the interface unit 240 through the mode setting port group 270. After the processing unit 122 obtains the mode signal 260 from the register 241, it controls the control unit 123 to operate in a normal mode. Thus, the host 140 can be coupled to the non-volatile memory controller 1100 through the host access port group 124 to access the non-volatile memory 160 or 170.

To update the firmware stored in the first non-volatile memory 160 (in the present embodiment, it is assumed that the firmware is stored in the non-volatile memory 160), the processing unit 122 disables the interface unit 240 according to the mode signal 260 and controls the control unit 123 to operate in a firmware updating mode. The control unit 123 is under the control of the firmware download port group 126 in this firmware updating mode. Accordingly, the external fixture 180 sends an instruction and a new firmware to the control unit 123 through the firmware download port group 126. The control unit 123 writes the new firmware into the first non-volatile memory 160 through the first memory port group 125, so as to update the firmware stored in the first non-volatile memory 160, according to the instruction issued by the fixture 180.

The processing unit 122 disables the interface circuit 121 according to the mode signal 260. Then, the fixture 180 connected to the second memory port group 126 (i.e., the firmware download port group) issues an instruction to the control unit 123, and accordingly the control unit 123 updates the firmware stored in the first non-volatile memory 160 through the first memory port group 125. Thereby, in the present embodiment, the fixture 180 can update the firmware in the first non-volatile memory 160 directly through the control unit 123. During the firmware updating process described above, the problem of bus contention can be avoided. Accordingly, the non-volatile memory controller 1100 in the present invention can update a firmware directly on a printed circuit board, and accordingly firmware updating is made more convenient.

The firmware updating process described above can be appropriately changed by those having ordinary knowledge in the art according to the embodiment described above. For example, in another embodiment of the present invention, the processing unit 122 may switch the electrical path between the control unit 123 and an internal bus of the non-volatile memory controller 1100 to a floating state (i.e., an off state) according to the mode signal 260. In other words, the processing unit 122 may temporarily disable the connection between the control unit 123 and the internal bus of the non-volatile memory controller 1100 according to the logic state of the mode signal 260 received through the mode setting port group 270. Then, the fixture 180 may send an instruction and a new firmware to the control unit 123 through the second memory port group 126 (i.e., the firmware download port group) without being affected by the internal bus of the non-volatile memory controller 1100. After that, the control unit 123 can write the new firmware into the first non-volatile memory 160 through the first memory port group 125.

If the mode signal 260 indicates that the firmware is not to be updated and the fixture 180 for updating the firmware has been removed, the host 140 can still access the non-volatile memories 160 and 170 through the non-volatile memory controller 1100. If the mode signal 260 indicates that the firmware is to be updated, the processing unit 122 transmits a chip selection signal to the second non-volatile memory 170 according to the logic state of the mode setting port group 270 to disable the second non-volatile memory 170 so that the second memory port group 126 can be served as the firmware download port group. By sharing the port group, less layout area is taken by port groups (or bounding pads) in the non-volatile memory controller 1100 and accordingly the fabrication cost is reduced.

In the embodiment described above, the non-volatile memory controller 1100 and the non-volatile memories 160 and 170 can be integrated into the same IC (or chip) or respectively implemented in different ICs (or chips). If the non-volatile memory controller 1100 and the non-volatile memories 160 and 170 are respectively implemented in different ICs (or chips), they can be fabricated through any packaging technique. For example, the non-volatile memory controller 1100 and the non-volatile memories 160 and 170 can be packaged together into a MCP. Or, the non-volatile memory controller 1100 and the non-volatile memories 160 and 170 can be respectively packaged into different IC packages.

### Fifth Embodiment

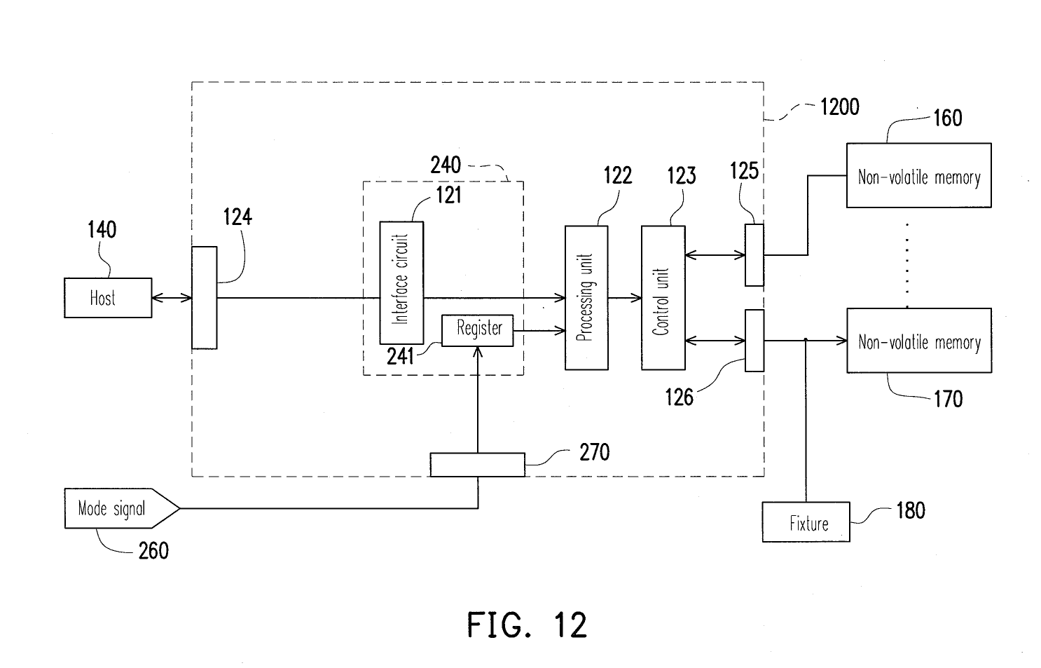

FIG. 12 is a functional block diagram of a non-volatile memory controller according to another embodiment of the present invention. Referring to FIG. 12, different from the fourth embodiment, the processing unit 122 of the non-volatile memory controller 1200 in the present embodiment is connected in series between the interface unit 240 and the control unit 123. When the firmware is to be updated, the mode signal 260 is transmitted to the register 241 through the mode setting port group 270. After the processing unit 122 receives the mode signal 260 from the register 241, it controls the control unit 123 according to the logic state of the mode signal 260 to determine whether the control unit 123 executes the instruction received through the firmware download port group (i.e., the second memory port group 126). The processing unit 122 disables the interface unit 240 according to the logic state of the mode setting port group 270 and controls the control unit 123 through the firmware download port group 126. Then, the fixture 180 sends an instruction and a new firmware to the control unit 123 through the firmware download port group 126, and the control unit 123 writes the new firmware into the first non-volatile memory 160 through the first memory port group 125.

The firmware updating process described above may also be appropriately changed by those having ordinary knowledge in the art according to the description of the fifth embodiment. For example, in another embodiment of the present invention, the processing unit 122 may switch the electrical path between the control unit 123 and an internal bus of a non-volatile memory controller 1200 to a floating state (i.e., an off state) according to the mode signal 260. Namely, the processing unit 122 may temporarily disable the connection between the control unit 123 and the internal bus of the non-volatile memory controller 1200 according to the logic state of the mode signal 260 received through the mode setting port group 270. Then, the fixture 180 can send an instruction and a new firmware to the control unit 123 through the second memory port group 126 (i.e., the firmware download port group) without being affected by the internal bus of the non-volatile memory controller 1200. After that, the control unit 123 can write the new firmware into the first non-volatile memory 160 through the first memory port group 125.

The non-volatile memory controller in foregoing first, second, third, fourth and fifth embodiment has a plurality of port groups, such as the host access port group 124, the firmware download port group 280, the mode setting port group 270, and the memory port groups 125 and 126. If the non-volatile memory controller and the non-volatile memory are packaged together into a MCP (for example, a memory card package), since the memory port groups 125 and 126 are packaged inside the MCP, there is no need to dispose corresponding pins of the memory port groups 125 and 126 on the surface of the MCP. Herein the surface of the MCP for disposing the pins corresponding to the host access port group 124 is defined as a “lower side” and which is to be soldered on a printed circuit board (PCB, not shown). The firmware download port group 280 and the mode setting port group 270 can be respectively disposed on the lower side or an upper side of the MCP. For example, the firmware download port group 126 or 280 and the mode setting port group 270 may be both disposed on the upper side or the lower side of the MCP, or the two may also be disposed on different sides of the MCP. Generally, the host access port group 124 can be disposed in the center area of the lower side of the MCP to be soldered on the PCB. The firmware download port group 126 or 280 can be disposed at an edge area of the lower side of the MCP, and the mode setting port group may also be disposed at the edge area of the lower side of the MCP.

Besides, if the non-volatile memory controller 200, 400, 500, 1100 or 1200 and the non-volatile memories 160 and 170 are individually packaged, the port groups thereof may be disposed as following:

1. The host access port group 124 and the memory port groups 125 and 126 are disposed at a packaged lower side of the non-volatile memory controller to be soldered on a PCB. The firmware download port group 126 or 280 and the mode setting port group 270 may be deposed on the same side (the upper side or the lower side) or different sides of the package.

2. If the host access port group 124 and the memory port groups 125 and 126 are disposed in the center area of the packaged lower side of the non-volatile memory controller, the firmware download port group 126 or 280 may be disposed at an edge area of the packaged lower side of the non-volatile memory controller, and the mode setting port group 270 may also be disposed at the edge area of the packaged lower side of the non-volatile memory controller.

The dispositions of foregoing port groups are not limited to the pattern described in the present embodiment; instead, they can be determined according to the actual requirement of circuit layout by those having ordinary knowledge in the art. The disposition of the firmware download port group in some embodiments of the present invention will be described below with reference to structure diagrams and exploded views of MCPs.

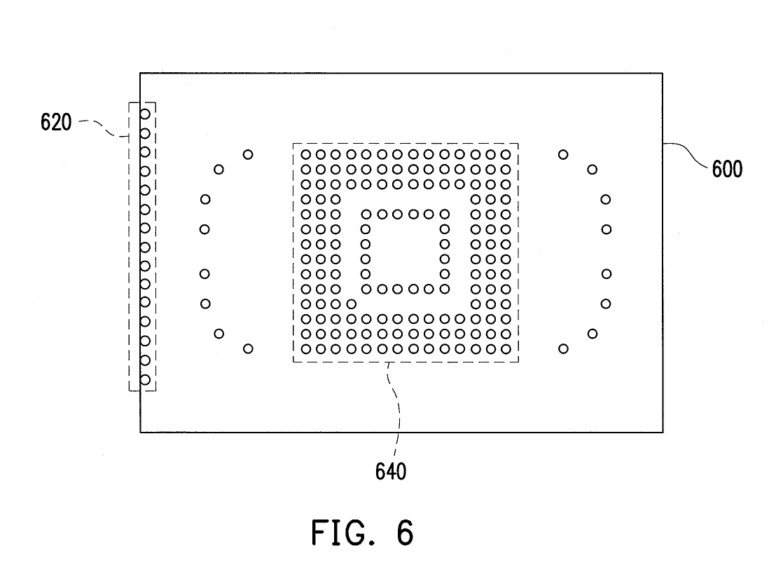

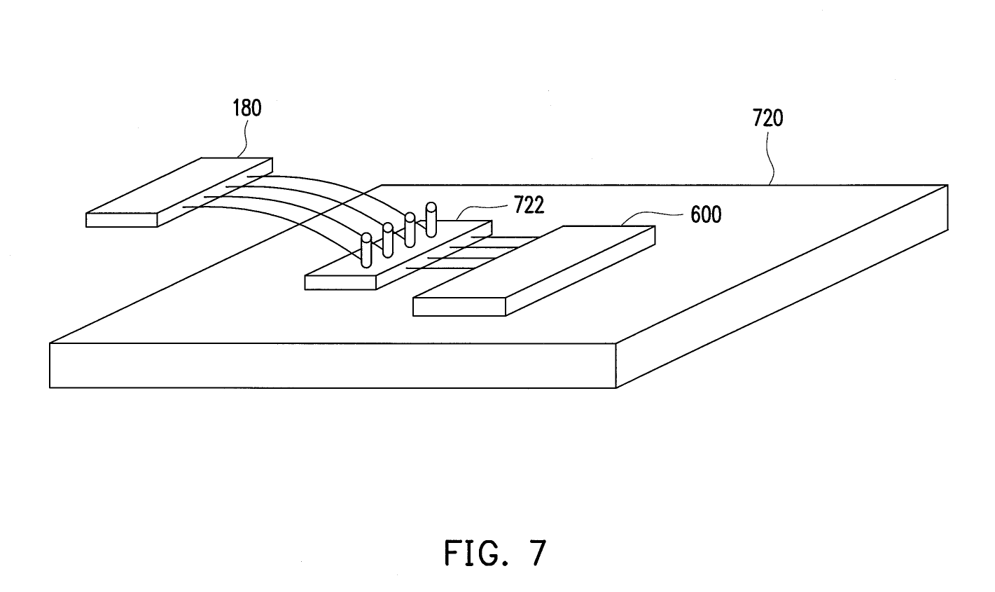

FIG. 6 is a diagram illustrating the disposition of pins of a MCP according to an embodiment of the present invention. Referring to FIG. 6, a lower side of a MCP 600 is illustrated. The MCP 600 includes a non-volatile memory controller and a non-volatile memory. The MCP 600 may be a memory card. The layout of the port group 640 in the center area of the lower side of the MCP 600 can be determined by a designer. The port group 640 may include a power port group, a ground port group, and a host access port group. More importantly, in the present invention, the firmware download port group 620 (equivalent to the firmware download port group 126 or 280 in FIG. 2, 4, or 5) can be disposed at an edge area of the lower side of the MCP 600 to reduce the complexity of the circuit layout and the difficulty for wiring to an external fixture. The connection between the MCP 600 and the fixture will be described with reference to FIG. 7.

FIG. 7 is a perspective view illustrating the connection between the MCP 600 and the fixture 180 according to an embodiment of the present invention. Referring to both FIG. 6 and FIG. 7, the MCP 600 and a connector 722 are disposed on the PCB 720. The MCP 600 is soldered on the PCB 720, namely, the pins on the back of the MCP 600 in FIG. 6 (for example, the firmware download port group 620 in FIG. 6) are soldered on the PCB 720. The firmware download port group 620 is connected to the connector 722 through the layout of the PCB 720. Even though a male connector is illustrated in FIG. 7 for representing the connector 722, the implementation of the connector 722 is not limited thereto, and the connection between the fixture 180 and the connector 722 is not limited to the pattern illustrated in FIG. 7. For example, in another embodiment of the present invention, the fixture 180 may have a plurality of probes for contacting the connector 722, and the connector 722 may be a female connector (socket) having a plurality of holes. Accordingly, the fixture 180 and the connector 722 can be electrically connected to each other by inserting the probes into the holes of the connector 722.

The fixture 180 is connected to a non-volatile memory controller (for example, the non-volatile memory controller in FIG. 2, 4, or 5) in the MCP 600 through the connector 722 and the firmware download port group 620. Thus, a firmware updating operation can be carried out according to the embodiments described above to allow the fixture 180 to write a new firmware into the non-volatile memory 160. The process and method for updating the firmware will not be described herein.

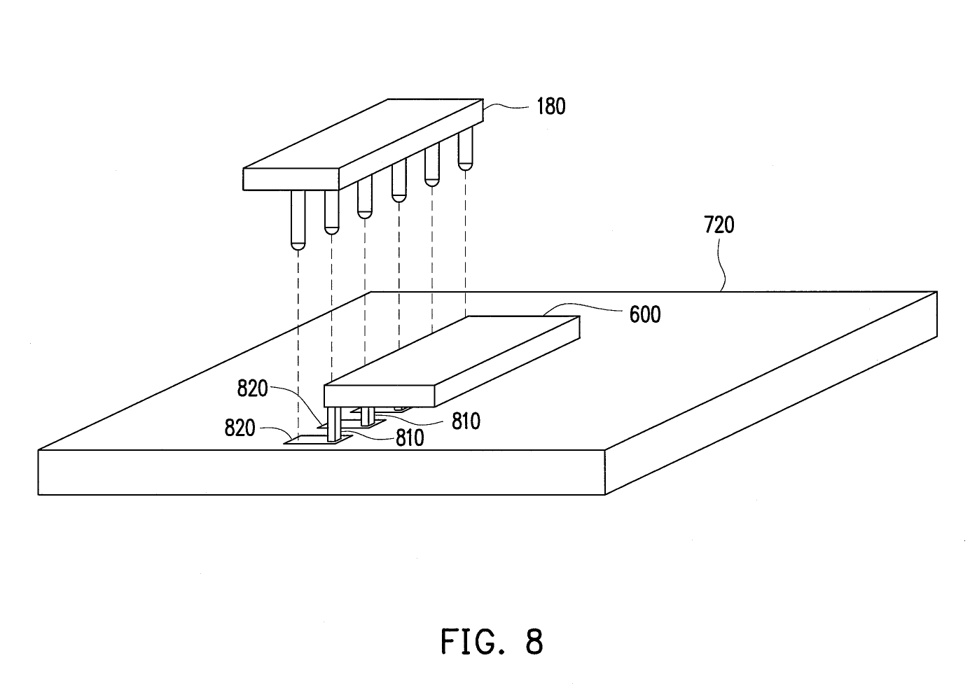

FIG. 8 is an exploded view illustrating the connection between a MCP and a fixture according to another embodiment of the present invention. Referring to FIG. 8, the major difference between FIG. 8 and FIG. 7 is that the connector 722 is omitted in FIG. 8. Bounding pads 820 are respectively disposed on the surface of the PCB 720 corresponding to the pins 810 of the firmware download port group 620 at the edge area of the lower side of the MCP 600. The bounding pads 820 respectively have an extension towards the opposite direction of the MCP 600, and the probes of the fixture 180 respectively contact the corresponding extensions of the bounding pads 820. Since the firmware download port group 620 is disposed at the edge area of the lower side of the MCP 600, only a small portion of the surface area of the PCB 720 is taken by the bounding pads 820 and the extensions thereof.

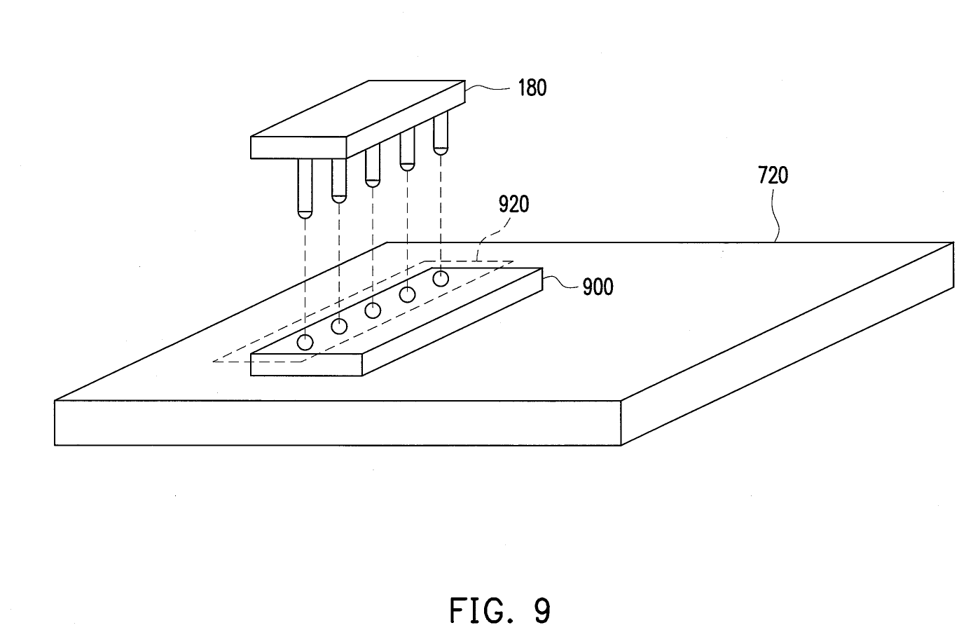

FIG. 9 is an exploded view illustrating the connection between a MCP and a fixture according to yet another embodiment of the present invention. Referring to FIG. 9, the difference between the MCP 900 and the MCP 600 in FIG. 6 is about the disposed position of the firmware download port group. The firmware download port group 620 in FIG. 6 is disposed at the edge area of the lower side of the MCP 600; instead, the firmware download port group 920 in FIG. 9 is disposed on an upper side of the MCP 900. Since the firmware download port group 920 is disposed on top of the MCP 900, the probes of the fixture 180 can directly contact the firmware download port group 920. Since the firmware download port group 920 is disposed on top of the MCP 900, it does not take up any layout area of the PCB 720 and the connection of the fixture 180 is made very convenient.

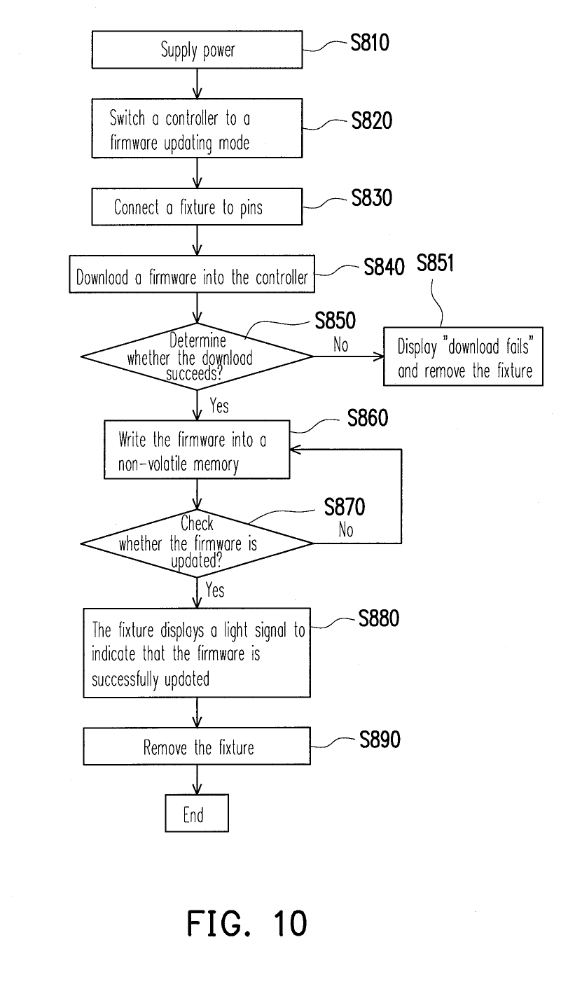

FIG. 10 is a flowchart of a firmware updating process according to an embodiment of the present invention. First, in step S810, a power is supplied to the non-volatile memory controller and the non-volatile memory. Then, in step S820, a mode signal is set to allow the processing unit to issue an instruction such that a switch module is switched to a firmware updating port (for example, the firmware download port group 280 in FIG. 2). Accordingly, the non-volatile memory controller is switched to a firmware updating mode. Next, in step S830, a fixture for updating the firmware is connected to the pins of the non-volatile memory controller. After that, in step S840, the fixture downloads the firmware into the non-volatile memory controller. Next, in step S850, the fixture determines whether the firmware is downloaded successfully. If the download fails (i.e., “no” in step S850), in step S851, the fixture displays “download fails” and is removed. Contrarily, if the download succeeds (i.e., “yes” in step S850), in step S860, the processing unit issues an instruction to the control unit to write the new firmware into the non-volatile memory through the control unit. Thereafter, in step S870, the fixture issues an instruction to enquire the non-volatile memory controller that whether the firmware updating is completed. If the update fails (i.e., “no” in step S870), step S860 is repeated and the fixture issues an instruction to let the processing unit to update the firmware again. Contrarily, if the update succeeds (i.e., “yes” in step S870), in step S880, the non-volatile memory controller responds a message of “update completes” to the fixture and the fixture displays a success indicator (for example, a flashing light signal). Eventually, in step S890, the fixture is removed to complete the firmware updating process.

As described above, the non-volatile memory controller provided by the present invention can update a firmware in a non-volatile memory without taking out the non-volatile memory. As a result, firmware updating is made very convenient. Moreover, different disposition patterns of pins for connecting a fixture are provided by the present invention such that the convenience in firmware updating is further improved and less surface area is taken by the pins.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A non-volatile memory controller, providing a process interface to allow a host to access a non-volatile memory, the non-volatile memory controller comprising:
a mode setting port group;
a firmware download port group, for receiving a new firmware;
a host access port group, for coupling to the host;
a memory port group, for coupling to the non-volatile memory;
a control unit, coupled to the memory port group;
a processing unit, coupled to the control unit, wherein the processing unit accesses the non-volatile memory through the control unit;
an interface unit, coupled to the processing unit; and
a switch unit, having a first terminal coupled to the host access port group, a second terminal coupled to the firmware download port group, and a third terminal coupled to the interface unit, wherein the processing unit controls the switch unit to couple the third terminal to the first terminal or the second terminal according to a logic state received by the mode setting port group.

2. The non-volatile memory controller according to claim 1, being packaged with the non-volatile memory in a multi-chip package (MCP).

3. The non-volatile memory controller according to claim 2, wherein the host access port group is disposed at a lower side of the MCP to be soldered on a printed circuit board (PCB), and the firmware download port group is disposed on an upper side of the MCP.

4. The non-volatile memory controller according to claim 3, wherein the mode setting port group is disposed on the upper side of the MCP.

5. The non-volatile memory controller according to claim 2, wherein the host access port group is disposed in the center area of a lower side of the MCP to be soldered on a PCB, and the firmware download port group is disposed at an edge area of the lower side of the MCP.

6. The non-volatile memory controller according to claim 5, wherein the mode setting port group is disposed at the edge area of the lower side of the MCP.

7. The non-volatile memory controller according to claim 1, wherein the host access port group and the memory port group are disposed at a packaged lower side of the non-volatile memory controller to be soldered on a PCB, and the firmware download port group is disposed on a packaged upper side of the non-volatile memory controller.

8. The non-volatile memory controller according to claim 7, wherein the mode setting port group is disposed on the packaged upper side of the non-volatile memory controller.

9. The non-volatile memory controller according to claim 1, wherein the host access port group and the memory port group are disposed in the center area of a packaged lower side of the non-volatile memory controller to be soldered on a PCB, and the firmware download port group is disposed at an edge area of the packaged lower side of the non-volatile memory controller.

10. The non-volatile memory controller according to claim 9, wherein the mode setting port group is disposed at the edge area of the packaged lower side of the non-volatile memory controller.

11. The non-volatile memory controller according to claim 1, wherein the switch unit is a multiplexer.

12. The non-volatile memory controller according to claim 1, wherein the switch unit is a switch.

13. The non-volatile memory controller according to claim 1, further serving the firmware download port group as a second memory port group to be coupled to a second non-volatile memory, wherein the control unit is further coupled to the second memory port group to allow the processing unit to access the second non-volatile memory through the control unit.

14. The non-volatile memory controller according to claim 13, wherein the processing unit disables the switch unit and the interface unit according to a logic state received by the mode setting port group, so that a fixture sends an instruction and the new firmware to the control unit through the second memory port group and the control unit writes the new firmware into the non-volatile memory through the memory port group.

15. The non-volatile memory controller according to claim 13, wherein the processing unit disables a connection between the control unit and an internal bus of the non-volatile memory controller according to a logic state received by the mode setting port group, so that a fixture sends an instruction and the new firmware to the control unit through the second memory port group and the control unit writes the new firmware into the non-volatile memory through the memory port group.

16. A memory card, comprising:
a non-volatile memory; and
a non-volatile memory controller, comprising:
a mode setting port group;
a firmware download port group, for receiving a new firmware;
a host access port group, coupled to a host;
a memory port group, coupled to the non-volatile memory;
a control unit, coupled to the memory port group;
a processing unit, coupled to the control unit, wherein the processing unit accesses the non-volatile memory through the control unit;
an interface unit, coupled to the processing unit; and
a switch unit, having a first terminal coupled to the host, a second terminal coupled to the firmware download port group, and a third terminal coupled to the interface unit, wherein the processing unit controls the switch unit to couple the third terminal to the first terminal or the second terminal according to a logic state received by the mode setting port group.

17. The memory card according to claim 16, wherein the non-volatile memory controller and the non-volatile memory are both packaged in a MCP.

18. The memory card according to claim 17, wherein the host access port group is disposed on a lower side of the MCP to be soldered on a PCB, and the firmware download port group is disposed on an upper side of the MCP.

19. The memory card according to claim 18, wherein the mode setting port group is disposed on the upper side of the MCP.

20. The memory card according to claim 17, wherein the host access port group is disposed in the center area of a lower side of the MCP to be soldered on a PCB, and the firmware download port group is disposed at an edge area of the lower side of the MCP.

21. The memory card according to claim 20, wherein the mode setting port group is disposed at the edge area of the lower side of the MCP.

22. The memory card according to claim 16, wherein the host access port group and the memory port group are disposed at a packaged lower side of the non-volatile memory controller to be soldered on a PCB, and the firmware download port group is disposed on a packaged upper side of the non-volatile memory controller.

23. The memory card according to claim 22, wherein the mode setting port group is disposed on the packaged upper side of the non-volatile memory controller.

24. The memory card according to claim 16, wherein the host access port group and the memory port group are disposed in the center area of a packaged lower side of the non-volatile memory controller to be soldered on a PCB, and the firmware download port group is disposed at an edge area of the packaged lower side of the non-volatile memory controller.

25. The memory card according to claim 24, wherein the mode setting port group is disposed at the edge area of the packaged lower side of the non-volatile memory controller.

26. The memory card according to claim 16, wherein the switch unit is a multiplexer.

27. The memory card according to claim 16, wherein the switch unit is a switch.

28. The memory card according to claim 16, further serving the firmware download port group as a second memory port group to be coupled to a second non-volatile memory, wherein the control unit is further coupled to the second memory port group to allow the processing unit to access the second non-volatile memory through the control unit.

29. The memory card according to claim 28, wherein the processing unit disables the switch unit and the interface unit according to a logic state received by the mode setting port group, so that a fixture sends an instruction and the new firmware to the control unit through the second memory port group and the control unit writes the new firmware into the non-volatile memory through the memory port group.

30. The memory card according to claim 28, wherein the processing unit disables a connection between the control unit and an internal bus of the non-volatile memory controller according to a logic state received by the mode setting port group, so that a fixture sends an instruction and the new firmware to the control unit through the second memory port group and the control unit writes the new firmware into the non-volatile memory through the memory port group.

31. A non-volatile memory controller, comprising:
a first memory port group, for coupling to a first non-volatile memory;
a second memory port group, for coupling to a second non-volatile memory, wherein the second memory port group is further served as a firmware download port group;
a control unit, coupled to the first memory port group and the second memory port group;
a processing unit, coupled to the control unit, wherein the processing unit accesses the first non-volatile memory or the second non-volatile memory through the control unit;
an interface unit, coupled to the processing unit, wherein the processing unit provides a process interface through the interface unit to allow a host to access the first non-volatile memory or the second non-volatile memory; and
a mode setting port group, wherein the processing unit controls the control unit according to a logic state of the mode setting port group to determine whether the control unit executes an instruction received through the firmware download port group.

32. The non-volatile memory controller according to claim 31, wherein the processing unit disables the interface unit according to the logic state of the mode setting port group and controls the control unit through the firmware download port group so that a fixture sends an instruction and a new firmware to the control unit through the firmware download port group and the control unit writes the new firmware into the first non-volatile memory through the first memory port group.

33. The non-volatile memory controller according to claim 31, wherein the processing unit disables a connection between the control unit and an internal bus of the non-volatile memory controller according to the logic state of the mode setting port group and controls the control unit through the firmware download port group so that a fixture sends an instruction and a new firmware to the control unit through the firmware download port group and the control unit writes the new firmware into the first non-volatile memory through the first memory port group.

34. The non-volatile memory controller according to claim 31, wherein the processing unit transmits a chip selection signal to the second non-volatile memory according to the logic state of the mode setting port group to disable the second non-volatile memory.

35. The non-volatile memory controller according to claim 31, being packaged in a MCP together with the first non-volatile memory and the second non-volatile memory.

36. The non-volatile memory controller according to claim 35, wherein the interface unit is connected to the host through a host access port group, wherein the host access port group is disposed at a lower side of the MCP to be soldered on a PCB, and the firmware download port group is disposed on an upper side of the MCP.

37. The non-volatile memory controller according to claim 36, wherein the mode setting port group is disposed on the upper side of the MCP.

38. The non-volatile memory controller according to claim 35, wherein the interface unit is connected to the host through a host access port group, wherein the host access port group is disposed in a center area of the lower side of the MCP to be soldered on a PCB, and the firmware download port group is disposed at an edge area of the lower side of the MCP.

39. The non-volatile memory controller according to claim 38, wherein the mode setting port group is disposed at the edge area of the lower side of the MCP.

40. The non-volatile memory controller according to claim 31, wherein the first memory port group is disposed at a packaged lower side of the non-volatile memory controller to be soldered on a PCB, and the firmware download port group is disposed on a packaged upper side of the non-volatile memory controller.

41. The non-volatile memory controller according to claim 40, wherein the mode setting port group is disposed on the packaged upper side of the non-volatile memory controller.

42. The non-volatile memory controller according to claim 31, wherein the first memory port group is disposed in a center area of the packaged lower side of the non-volatile memory controller to be soldered on a PCB, and the firmware download port group is disposed at an edge area of the packaged lower side of the non-volatile memory controller.

43. The non-volatile memory controller according to claim 42, wherein the mode setting port group is disposed at an edge area of the packaged lower side of the non-volatile memory controller.

44. A memory card, comprising:
a first non-volatile memory;
a second non-volatile memory; and
a non-volatile memory controller, comprising:
a first memory port group, for coupling to the first non-volatile memory;
a second memory port group, for coupling to the second non-volatile memory, wherein the second memory port group is further served as a firmware download port group;
a control unit, coupled to the first memory port group and the second memory port group;
a processing unit, coupled to the control unit, wherein the processing unit accesses the first non-volatile memory or the second non-volatile memory through the control unit;
an interface unit, coupled to the processing unit, wherein the processing unit provides a process interface through the interface unit to allow a host to access the first non-volatile memory or the second non-volatile memory; and
a mode setting port group, wherein the processing unit controls the control unit according to a logic state of the mode setting port group to determine whether the control unit executes an instruction received through the firmware download port group.

45. The memory card according to claim 44, wherein the processing unit disables the interface unit according to the logic state of the mode setting port group and controls the control unit through the firmware download port group so that a fixture sends an instruction and a new firmware to the control unit through the firmware download port group and the control unit writes the new firmware into the first non-volatile memory through the first memory port group.

46. The memory card according to claim 44, wherein the processing unit disables a connection between the control unit and an internal bus of the non-volatile memory controller according to the logic state of the mode setting port group and controls the control unit through the firmware download port group so that a fixture sends an instruction and a new firmware to the control unit through the firmware download port group and the control unit writes the new firmware into the first non-volatile memory through the first memory port group.

47. The memory card according to claim 44, wherein the processing unit transmits a chip selection signal to the second non-volatile memory according to the logic state of the mode setting port group to disable the second non-volatile memory.

48. The memory card according to claim 44, wherein the first non-volatile memory, the second non-volatile memory, and the non-volatile memory controller are packaged together in a MCP.

49. The memory card according to claim 48, wherein the interface unit is connected to the host through a host access port group, wherein the host access port group is disposed at a lower side of the MCP to be soldered on a PCB, and the firmware download port group is disposed on an upper side of the MCP.

50. The memory card according to claim 49, wherein the mode setting port group is disposed on the upper side of the MCP.

51. The memory card according to claim 48, wherein the interface unit is connected to the host through a host access port group, wherein the host access port group is disposed in a center area of the lower side of the MCP to be soldered on a PCB, and the firmware download port group is disposed at an edge area of the lower side of the MCP.

52. The memory card according to claim 51, wherein the mode setting port group is disposed at the edge area of the lower side of the MCP.

53. The memory card according to claim 44, wherein the first memory port group is disposed at a packaged lower side of the non-volatile memory controller to be soldered on a PCB, and the firmware download port group is disposed on a packaged upper side of the non-volatile memory controller.

54. The memory card according to claim 53, wherein the mode setting port group is disposed on the packaged upper side of the non-volatile memory controller.

55. The memory card according to claim 44, wherein the first memory port group is disposed in a center area of the packaged lower side of the non-volatile memory controller to be soldered on a PCB, and the firmware download port group is disposed at an edge area of the packaged lower side of the non-volatile memory controller.

56. The memory card according to claim 55, wherein the mode setting port group is disposed at the edge area of the packaged lower side of the non-volatile memory controller.
